(19) United States
(12) Patent Application Publication
(10) Pub. No.: US 2022/0079405 A1
(43) Pub. Date: Mar. 17, 2022

(54) VACCUM CLEANER

(71) Applicant: Samsung Electronics Co., Ltd., Suwon-si, Gyeonggi-do (KR)

(72) Inventors: Donghoun YANG, Suwon-si (KR); Kyoungwoung KIM, Suwon-si (KR); Shin KIM, Suwon-si (KR); Seongu LEE, Suwon-si (KR); Byeongheon JUNG, Suwon-si (KR)

(73) Assignee: Samsung Electronics Co., Ltd., Suwon-si (KR)

(21) Appl. No.: 17/421,545

(22) PCT Filed: Nov. 29, 2019
(86) PCT No.: PCT/KR2019/016727

§ 371 Date: Jul. 8, 2021

(30) Foreign Application Priority Data
Jan. 11, 2019 (KR) 10-2019-0003956

(51) Int. Cl. A47L 9/28; A47L 5/26; A47L 9/04; A47L 9/24; A47L 9/14; A47L 9/32; A46B 13/00; A46B 13/02; A46D 1/00

(52) U.S. Cl. CPC A47L 9/2889; A47L 5/26; A47L 9/0477; A47L 9/0411; A47L 9/2884; A47L 9/246; A46B 2200/3033; A47L 9/1409; A47L 9/322; A46B 13/001; A46B 13/02; A46D 1/0207; A47L 9/248

(57) ABSTRACT

A vacuum cleaner comprising: a cleaner main body configured to generate suction power; and a suction unit configured to suck dust using the suction power. The suction unit comprising: a drum brush comprising a cylindrical drum rotatable to brush away dust from a floor, and conductive bristles provided on an outer circumferential surface of the drum; and a conductive dust guide unit comprising a guide portion connectable to the cleaner main body and configured to guide the sucked dust to be transferred to the cleaner main body, and a contact portion formed to extend from the guide portion, provided to be in contact with the bristles of the drum brush, and configured to transfer static electricity, which is charged as the vacuum cleaner is operated, from the cleaner main body to the conductive bristles of the drum brush.

### CROSS-REFERENCE TO RELATED APPLICATIONS

This application is a U.S. National Stage Application, which claims the benefit under 35 U.S.C. § 371 of International Patent Application No. PCT/KR2019/016727, filed on Nov. 29, 2019, which claims the priority benefit of Korean Patent Application No. 10-2019-0003956, filed on Jan. 11, 2019 in the Korean Patent and Trademark Office, the disclosures of which are hereby incorporated by reference in their entirety.

### BACKGROUND

### Field

The disclosure relates to a vacuum cleaner having an electrostatic discharge function.

### Description of the Related Art

A stick vacuum cleaner includes a cleaner main body for generating suction power, a suction unit for sucking dust or foreign materials from a carpet or the like surface to be cleaned, and a stick with a connection pipe having a passage through which the dust or foreign materials sucked by the suction unit are transferred. The stick may have an upper end to which the cleaner main body is connected, and a lower end to which the suction unit is connected. The cleaner main body may include a dust box in which the dust or foreign materials sucked through the stick are collected. The suction unit includes a rotatable drum brush and a motor for rotating the drum brush.

Meanwhile, the dust sucked through the suction unit moves having friction with a dust guide of the suction unit, the connection pipe, and the dust box. In this case, the dust has static electricity, and therefore the dust guide, the connection pipe and the dust box are charged with the static electricity by the friction in a suction process. Such charged static electricity is continuously accumulated and discharged to a user while the cleaner operates, thereby causing a problem that the user experiences discomfort.

### SUMMARY

According to an embodiment of the disclosure, there is provided a vacuum cleaner comprising: a cleaner main body configured to generate suction power; and a suction unit configured to suck dust by the suction power, the suction unit comprising: a drum brush comprising a cylindrical drum rotating to brush away dust from a floor, and conductive bristles provided on an outer circumferential surface of the drum; and a conductive dust guide unit comprising a guide portion connected to the cleaner main body and configured to guide the sucked dust to be transferred to the cleaner main body, and a contact portion extended from the guide portion, provided to be in contact with the bristles of the drum brush, and configured to transmit static electricity from the cleaner main body to the bristles of the drum brush.

The vacuum cleaner according to claim 1, further comprising: a drum motor configured to rotate the drum; and a motor wire configured to supply electric power from the cleaner main body to the drum motor, and provided to be in contact with the dust guide unit.

The vacuum cleaner according to claim 2, wherein the cleaner main body comprises a handy unit comprising a battery, and a connection pipe through which dust guided by the suction unit passes, and the motor wire is connected from the battery to the drum motor of the suction unit via the connection pipe and the dust guide.

The vacuum cleaner according to claim 3, wherein the cleaner main body comprises: a first connection unit connecting a first end portion of the connection pipe and the handy unit; and a second connection unit connecting a second end portion of the connection pipe and the suction unit.

The vacuum cleaner according to claim 4, wherein the motor wire comprises: a first power line extended from the battery of the handy unit toward the first end portion of the connection pipe; a second power line extended along the connection pipe; and a third power line extended from the drum motor toward the second end portion of the connection pipe.

The vacuum cleaner according to claim 5, wherein the cleaner main body comprises: a first connector electrically connecting the first power line and the second power line; and a second connector connecting the second power line and the third power line.

The vacuum cleaner according to claim 2, wherein the motor wire comprises a plurality of internal electric wires, and an external sheath covering the plurality of internal electric wires.

The vacuum cleaner according to claim 2, wherein the cleaner main body comprises a dust collecting box configured to collect dust transferred through the connection pipe, and the dust collecting box is in contact with the connection pipe.

The vacuum cleaner according to claim 2, wherein the cleaner main body comprises: a dust collecting box configured to collect dust transferred through the connection pipe; a grip configured to allow a user to control the vacuum cleaner; and a conductive line electrically connecting the dust collecting box and the grip.

The vacuum cleaner according to claim 1, wherein the drum brush is provided on the outer circumferential surface of the drum and comprises cleaning bristles to brush away dust from a floor, and the contact portion is configured to separate the dust by being in contact with the cleaning bristles of the drum brush.

The vacuum cleaner according to claim 1, wherein the dust guide unit comprises conductive plastic.

The vacuum cleaner according to claim 11, wherein the conductive plastic comprises plastic that contains a conductive filler.

The vacuum cleaner according to claim 1, wherein the dust guide unit is coated with a conductive material.

The vacuum cleaner according to claim 1, wherein the bristles comprise a conductive wire.

### BRIEF DESCRIPTION OF DRAWINGS

The above and/or the aspects will become apparent and more readily appreciated from the following description of exemplary embodiments, taken in conjunction with the accompanying drawings, in which:

FIG. 1 is a perspective view of a vacuum cleaner according to an embodiment of the disclosure.

FIG. 2 is a perspective view of a handy unit in FIG. 1.

FIG. 3 is a cross-sectional view, taken along line A-A in FIG. 2.

FIG. 4 is an exploded perspective view of a connection pipe in FIG. 1.

FIG. 5 is a cross-sectional view, taken along line B-B in FIG. 4.

FIG. 6 is a cross-sectional view of a motor wire in FIG. 4.

FIG. 7 is a perspective view of a suction unit in FIG. 1.

FIG. 8 is an exploded perspective view of the suction unit in FIG. 7.

FIG. 9 is a cross-sectional view, taken along line C-C in FIG. 7.

FIG. 10 is a perspective view of a dust guide unit in FIG. 8.

FIG. 11 is an assembled perspective view of a base unit and the dust guide unit in FIG. 8.

FIG. 12 is a perspective view of the suction unit in FIG. 1, viewed from below.

FIG. 13 is a perspective view of a suction unit from which an upper cover is separated.

### DETAILED DESCRIPTION

Hereinafter, various embodiments of the disclosure will be described in detail with reference to the drawings.

Below, embodiments of a vacuum cleaner 1 according to the disclosure will be described in detail with reference to the accompanying drawings. The embodiments set forth herein will be described as applied to a stick-type vacuum cleaner to help understanding of the disclosure, but these are for illustrative purposes only. In other words, it will be understood that the disclosure is applicable to various alternative embodiments such as a handy type, a handy-stick type, a canister type vacuum cleaner, an upright type vacuum cleaner, etc. unlike the embodiments set forth herein. However, in the following descriptions of the disclosure, detailed descriptions and specific drawings of relevant publicly-known functions or elements will be omitted if it is determined that they may unnecessarily cloud the gist of the disclosure.

Accordingly, an aspect of the disclosure is to provide a vacuum cleaner, in which static electricity that has been charged from dust while operating is continuously discharged to a surface-to-be-cleaned, thereby preventing a user from experiencing discomfort of static electric shock.

As described above, a vacuum cleaner according to the disclosure continuously discharges static electricity, which has been charged from dust while sucking the dust, to a surface-to-be-cleaned, thereby preventing the static electricity from being accumulated.

A vacuum cleaner according to the disclosure has a very simple mechanism for discharging static electricity, thereby reducing additional manufacturing costs for discharging the static electricity.

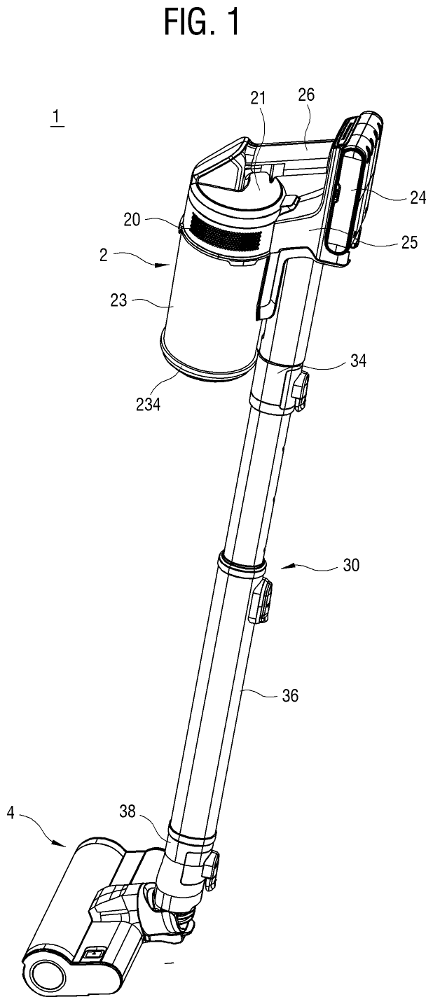

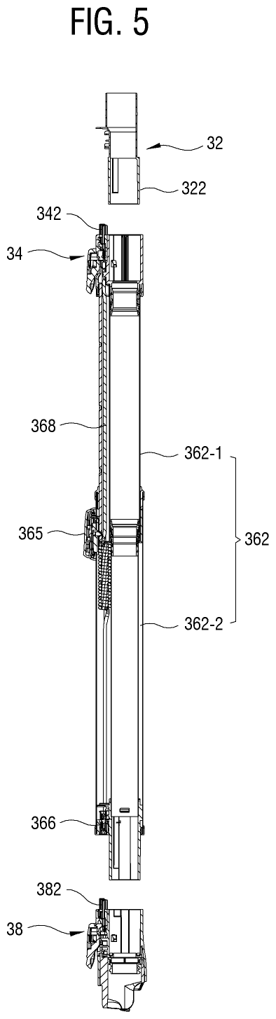

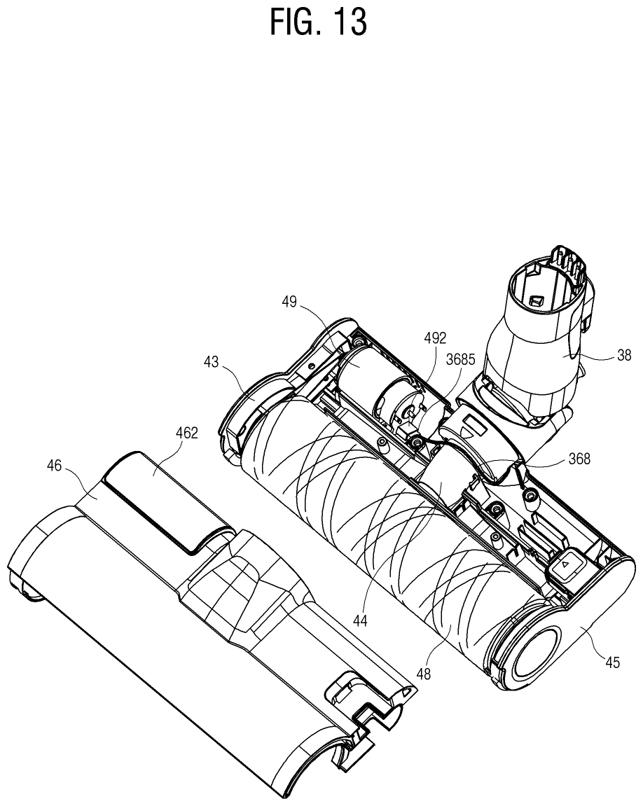

FIG. 1 is a perspective view of a vacuum cleaner 1 according to an embodiment of the disclosure. The vacuum cleaner 1 according to an embodiment of the disclosure includes a cleaner main body 2, and a suction unit 4 for sucking dust or foreign material from a surface-to-be-cleaned. The cleaner main body 2 includes a handy unit 20 for generating suction power, and a connection pipe 30. The vacuum cleaner 1 includes a motor wire (see ‘368’ in FIGS. 5 and 13) extended from the handy unit 20 to the suction unit 4 via the connection pipe 30.

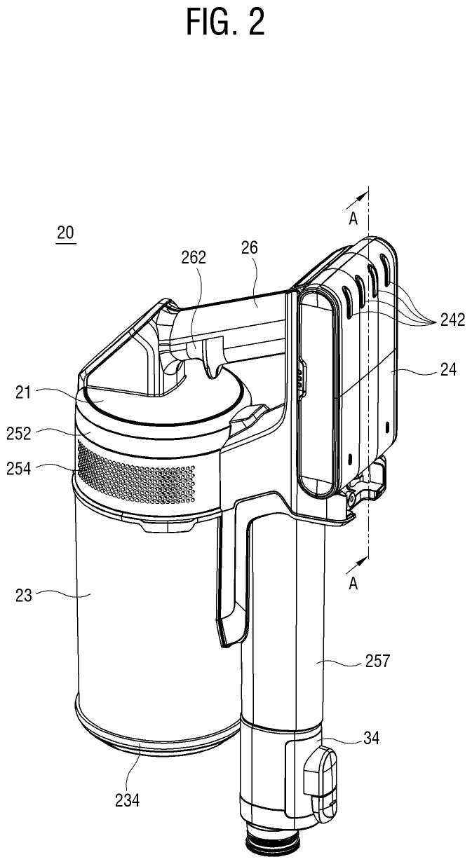

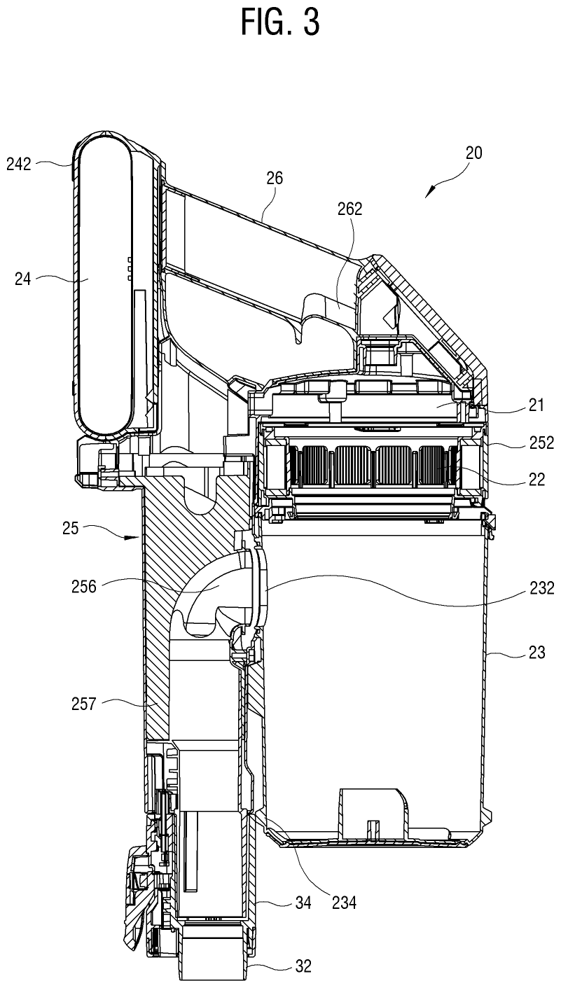

FIG. 2 is a perspective view of a handy unit in FIG. 1, and FIG. 3 is a cross-sectional view, taken along line A-A in FIG. 2. As shown therein, the handy unit 20 includes a suction motor 21 for generating the suction power, a dust filter 22 for filtering the sucked dust or foreign materials, a dust collecting box 23 for collecting the dust or foreign materials filtered through the dust filter 22, a battery 24 for supplying electric power to the suction motor 21, a mounting portion to which parts of the handy unit 20 are mounted, and a grip 26. The handy unit 20 may include a controller (not shown) for controlling the suction motor 21.

The suction motor 21 generates the suction power to suck dust or foreign materials.

The dust filter 22 is detachably coupled to the suction motor 21 and filters dust or foreign materials out of air sucked from the surface-to-be-cleaned by the suction power.

The dust collecting box 23 is shaped like, for example, a cylinder, and detachably mounted to the mounting portion 25 in order to filter out the dust sucked together with air by the suction power. The dust collecting box 23 has an opening to be hermetically coupled to a dust collecting filter 22. Further, the dust collecting box 23 is placed in the mounting portion 25 along the lengthwise direction of the connection pipe 30, and adjacent to the connection pipe 30. The dust collecting box 23 includes a dust inlet 232 at a lateral side, into which dust or foreign materials are introduced.

The dust collecting box 23 may for example include a cyclone system that uses spiral air currents to separate dust from air. The cyclone system collects the separated dust therein and expels air.

The dust collecting box 23 is continuously charged with static electricity by friction with dust sucked and filtered while the vacuum cleaner 1 operates. The dust collecting box 23 includes an electric discharging projection 234 to discharge such charged static electricity toward the connection pipe 30. The electric discharging projection 234 protrudes along a circumferential direction of the dust collecting box 23 so that the dust collecting box 23 can become into contact with the outer circumference of the connection pipe 30 when the dust collecting box 23 is mounted to the mounting portion 25. As necessary, the electric discharging projection 234 may be made of a conductive material or covered to have conductivity. The electric discharging projection 234 may for example be provided as a metal ring and mounted to the dust collecting box 23.

The battery 24 is detachably mounted to the mounting portion 25. The battery 24 may be embodied by a rechargeable secondary battery. The battery 24 supplies electric power to the suction motor 21 and the suction unit 4 (to be described later). The battery 24 includes a charging terminal 242.

The mounting portion 25 includes a cylindrical motor case 252 in which the suction motor 21 and the dust filter 22 are assembled and accommodated and to which the dust collecting box 23 is mounted, and a dust passage 257 of which one side is connected to the connection pipe 30 and the other side is connected to the dust inlet 232 of the dust collecting box 23 and which has a dust through hole 256. The motor case 252 may include a dust exhauster 254 to expel air from which sucked dust is removed. The mounting portion 25 may further include a driving circuit (not shown) for operating the cleaner, a first power line (not shown) for supplying the electric power from the battery 24 to the suction unit 4, etc.

Air inhaled on the surface-to-be-cleaned is introduced into the dust collecting box 23 through the dust through hole 256 via the connection pipe 30. Air with dust introduced into the dust collecting box 23 is expelled to the outside through the dust exhauster 254 after dust or foreign materials are filtered out by the dust filter 22.

The grip 26 has a shape suitable to be grabbed in a user's hand so that the user can control the vacuum cleaner 1. The grip 26 includes a control button 262 for controlling the vacuum cleaner 1.

According to an alternative embodiment, a conductive line (not shown) for connecting the dust collecting box 23 and the grip 26 may be provided instead of the electric discharging projection 234 of the dust collecting box 23. In this case, the static electricity to be transmitted to a user is very weak because it is not accumulated, and therefore a user cannot feel the static electricity.

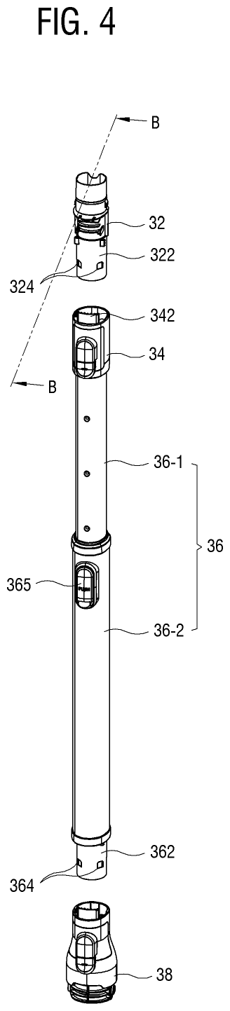

FIGS. 4 and 5 are an exploded perspective view of the connection pipe 30 in FIG. 1, and a cross-sectional view, taken along line B-B in FIG. 4. Referring to FIGS. 1, 4 and 5, the connection pipe 30 is shaped like a hollow pipe, and forms a passage through which dust or foreign materials sucked by the suction unit 4 are transferred to the suction motor 21 of the handy unit 20. The connection pipe 30 includes a first connection pipe 32, a first connection unit 34, a second connection pipe 36, and a second connection unit 38.

The first connection pipe 32 includes a first end portion inserted in and supported by the dust through hole (see ‘256’ in FIG. 3) of the mounting portion 25, and a second end portion connected to the first connection unit 34. The first connection pipe 32 has a circular hollow. The first connection pipe 32 includes a connecting end portion 322 in the second end portion. Further, the connecting end portion 322 includes a pair of locking-end accommodating grooves 324 spaced apart from each other in a circumferential direction. The first connection pipe 32 may include a female connector (not shown) which is connected to a first power line (not shown) drawn from the battery 24 of the handy unit 20 to supply electric power to a drum motor (see ‘49’ in FIG. 13), and locked to a male connector 342 of the first connection unit 34.

The first connection unit 34 has a first end portion detachably connected to the second end portion of the first connection pipe 32, and a second end portion supported in the first end portion of the second connection pipe 36. The first connection unit 34 includes the male connector 342 protruding at the first end portion and locked to a female connector (not shown) of the first connection pipe 32 when accommodating and coupling with the first connection pipe 32. Here, the second connection unit 34 and the second connection pipe 36 may be formed as a single body, or may be separately manufactured and assembled. The first connection unit 34 may include one side detachably coupled to the second end portion of the first connection pipe 32, and the other side supported on the first end portion of the second connection pipe 36.

The second connection pipe 36 includes a first end portion connected to the second end portion of the first connection unit 34, and a second end portion detachably connected to the second connection unit 38. The second connection pipe 36 may include a plurality of telescopic pipes 36-1 and 36-2 and be thus retractable. The second connection pipe 36 includes a stopper 365 to hold a position when the plurality of pipes 36-1 and 36-2 are stretched and retracted. The second connection pipe 36 includes the motor wire (or a second power line) 368 disposed in a lengthwise direction. The motor wire (i.e., the second power line) 368 has opposite ends connected to the male connector 342 of the first connection unit 34 and a female connector 366 of the second connection pipe 36. The second connection pipe 36 includes a connecting end portion 362 at the second end portion. The connecting end portion 362 includes a pair of locking-end accommodating grooves 364 arranged to be spaced apart in a circumferential direction. Further, the second connection pipe 36 includes the female connector 366, which is locked to a male connector 382 of the second connection unit 38, at the second end portion.

The second connection unit 38 may include a first end portion detachably connected to the second end portion of the second connection pipe 36, and a second end portion supported in the suction unit 4. The second connection unit 38 includes the male connector 382 protruding at the first end portion, and locked to the female connector 366 of the second connection pipe 36 when accommodating and coupling with the second connection pipe 36.

Selectively, the second connection unit 38 may include the first end portion supported in the second end portion of the second connection pipe 36. In this case, a third connection pipe (not shown) may be supported in the suction unit 4, and a first end portion of the third connection pipe may be detachably connected to the second end portion of the second connection unit 38.

According to an alternative embodiment, the second connection unit 38 of the connection pipe 30 may be omitted. Thus, the first connection unit 34 may include a first end portion detachably connected to the second end portion of the first connection pipe 32, and a second end portion supported in the first end portion of the second connection pipe 36. In this case, the second end portion of the second connection pipe 36 is supported in the suction unit 4 because the second connection unit 38 is not present.

According to another alternative embodiment, the first connection unit 34 and the first connection pipe 32 of the connection pipe 30 may be omitted. Thus, the second connection unit 38 may include the first end portion supported in the suction unit 4, and the second end portion detachably connected to the second end portion of the second connection pipe 36. In this case, the second end portion of the second connection pipe 36 is supported in the handy unit 20 because the first connection unit 34 and the first connection pipe 32 are not present.

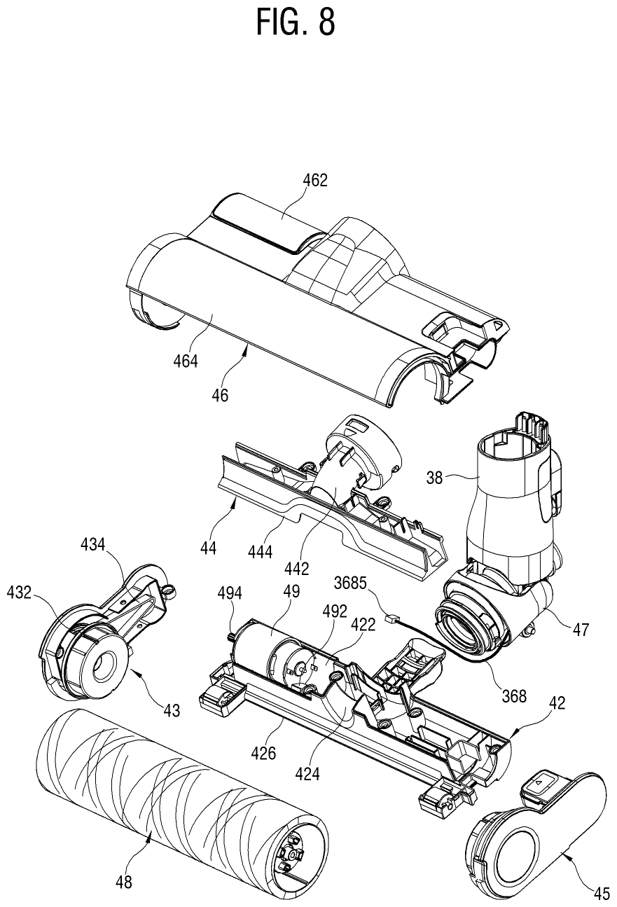

According to still another alternative embodiment, the vacuum cleaner 1 may include a conductive line (not shown), for example, an iron wire, a copper wire or the like conductive wire extended along the connection pipe 30 up to a guide portion (see ‘442’ in FIG. 8) and a contact portion (see ‘444’ in FIG. 8) of a dust guide unit (see ‘44’ in FIG. 8). In this case, the conductive line may be extended together with the motor wire 368, or may be separately provided. Of course, the conductive line may also be required to be detachably and electrically connected by the first connection unit 34 and the second connection unit 38 of the connection pipe 30.

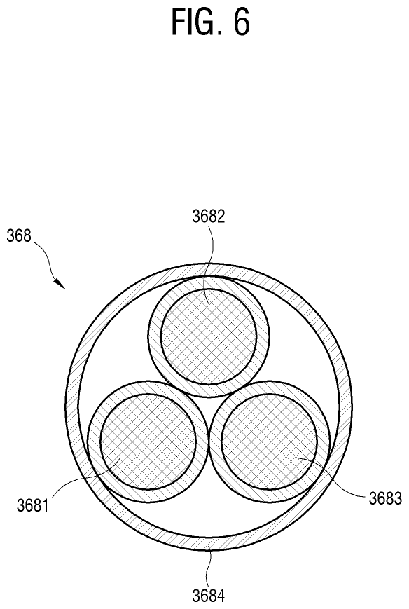

FIG. 6 is a cross-sectional view of the motor wire 368 in FIG. 4. As shown therein, the motor wire 368 includes a positive wire 3681, a negative wire 3682 and a ground wire 3683 which are coated with insulating materials, respectively. The positive wire 3681, the negative wire 3682 and the ground wire 3683 are all covered with an insulation sheath 3684. The insulation sheath 3684 may be made of silicon rubber, Teflon, polyvinyl chloride (PVC), polyethylene (PE), polypropylene (PP), polyamide (PA, or Nylon), polyethylene terephthalate (PET), etc. The motor wire 368 transmits static electricity, which is charged from sucked dust to the dust collecting box 23 and/or the connection pipe 30 while the vacuum cleaner 1 is operating, to the suction unit 4.

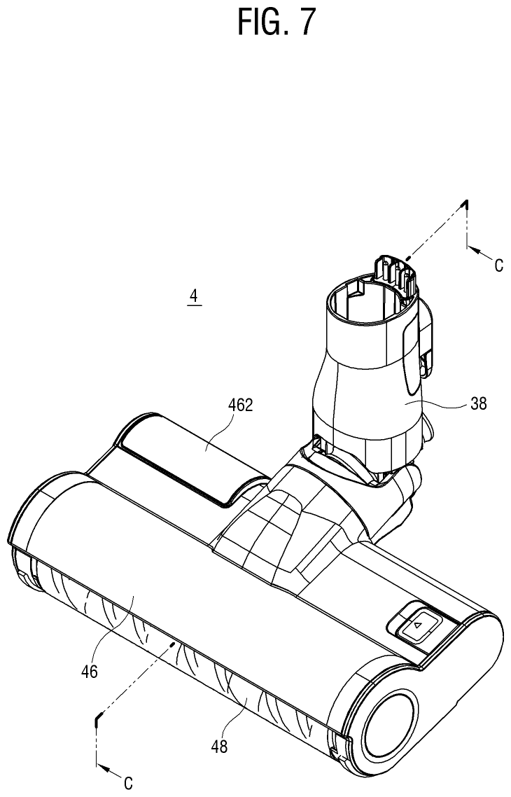

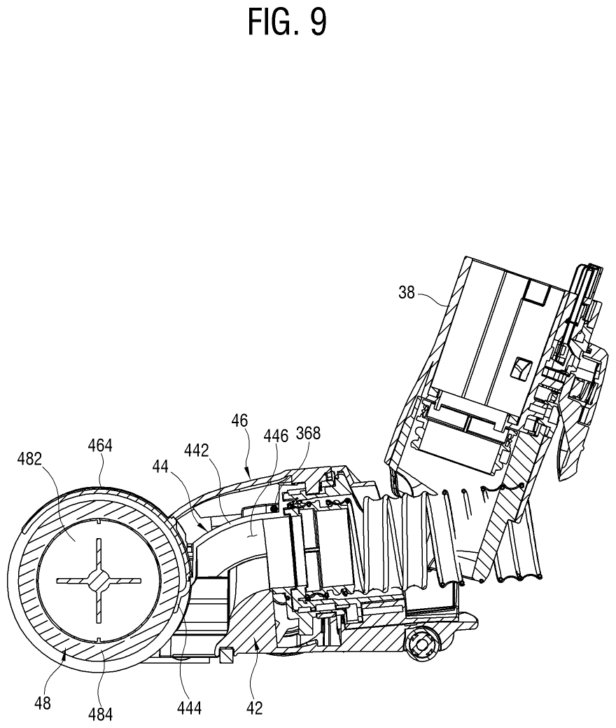

FIG. 7 is a perspective view of the suction unit 4 viewed from above, FIG. 8 is an exploded perspective view of the suction unit 4, and FIG. 9 is a cross-sectional view, taken along line C-C in FIG. 7.

As shown therein, the suction unit 4 includes a base unit 42, the dust guide unit 44 coupled to the base unit 42 and forming a suction space 446, an upper cover 46 covering an upper portion of the dust guide unit 44, a drum brush 48 rotating to clean dust on a surface-to-be-cleaned, and the drum motor 49 provided in the base unit 42 and driving the drum brush 48 to rotate.

The suction unit 4 may include a pipe connector 47 provided between the second connection unit 38 of the connection pipe 30 and the suction space 446 formed by the base unit 42 and the dust guide unit 44. The pipe connector 47 may include a first side connected to the suction space 446, and a second side connected to the second connection unit 38. The pipe connector 47 may be rotatably connected to an end portion of the second connection unit 38.

The base unit 42 may include a motor accommodating portion 422 to accommodate the drum motor 49, and a lower channel 424 having for example a semicylindrical shape and forming a lower side of the suction space 446. The base unit 42 includes an opening 426 opened toward a surface-to-be-cleaned on the floor. Dust may be introduced into the suction space 446 through the opening 426. The base unit 42 may include a plurality of rollers (not shown) for movement while being spaced from the floor.

The dust guide unit 44 includes the guide portion 442 to guide air that contains dust, and the contact portion 444 to become into contact with an outer circumference of the drum brush 48 and separate the dust from the drum brush 48. The motor wire (or a third power line) 368 for supplying power to the drum motor 49 is provided being in contact with an upper surface of the dust guide unit 44. The motor wire (i.e., the third power line) 368 includes opposite ends connected to the male connector 382 of the second connection unit 38 and a motor connector 3685.

The dust guide unit 44 may be made of conductive plastic to have conductivity. The conductive plastic may include a conductive filler, for example, plastic that contains nanoparticles of metal. The conductive plastic may contain polyacetylene.

According to an alternative embodiment, the dust guide unit 44 may be embodied by coating an insulating plastic with a conductive material. The conductive material may be formed on the entire surface or only a partial surface of the coating.

According to another alternative embodiment, the dust guide unit 44 may be embodied by a conductive contact member (not shown) provided in the contact portion 444 and extended in a lengthwise direction, and at least one conductive connecting member (not shown) adhered or coated onto the guide portion 442 and extended from the conductive contact member to the motor wire 368.

The upper cover 46 includes a motor covering portion 462 covering the drum motor 49, and a drum covering portion 464 partially covering the cylindrical drum brush 48. The drum covering portion 464 is disposed leaving a predetermined space from the outer circumferential surface of the drum brush 48.

The drum brush 48 brushes away dust from the surface-to-be cleaned on the floor, in particular, dust deeply attached between a plurality of fibres of a carpet, thereby scattering the dust above the carpet.

The drum brush 48 includes a drum 482 shaped like a cylindrical roller and rotating, and a cleaning member 484 provided on the outer circumferential surface of the drum 482. The cleaning member 484 includes, for example, a cleaning bristles such as flannel made of cotton yarn, and electric-discharging bristles such as silver yarn, carbon yarn or a conductive wire. The cleaning member 484 rotates being in contact with the contact portion 444 of the dust guide unit 44, and therefore the static electricity of the conductive dust guide unit 44 is transmitted to the electric-discharging bristles of the cleaning member 484 through the contact portion 444 and then discharged.

The drum brush 48 is rotatably provided in the base unit 42. The first end portion of the drum brush 48 is coupled to a power transmission coupler 43 for transmitting driving power of the drum motor 49. The power transmission coupler 43 includes a belt pulley 432 coupled to the first end portion of the drum 482, and a driving belt 434 mounted between the belt pulley 432 and a motor pulley 494 of the drum motor 49.

The drum motor 49 generates driving power to rotate the drum brush 48. The drum motor 49 receives electric power from the battery (see ‘24’ in FIG. 3) of the handy unit (see ‘20’ in FIG. 3) through the connection pipe (see ‘30’ in FIG. 1).

The drum motor 49 includes a female connector 492 to receive the electric power, and the motor pulley 494 to provide rotating power to the drum brush 48. The female connector 492 of the drum motor 49 is connected to the motor connector 3685 of the motor wire 368.

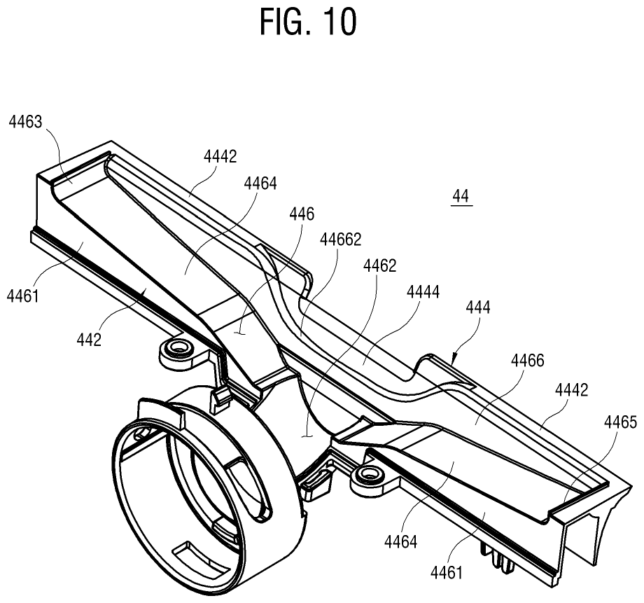

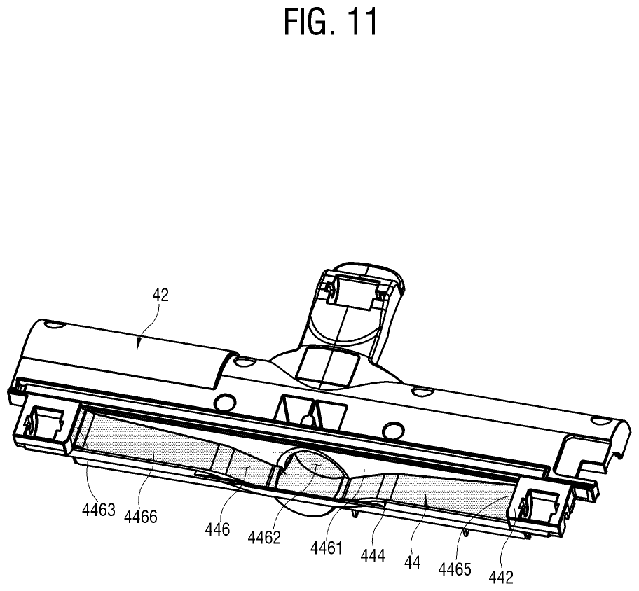

FIG. 10 is a perspective view of the dust guide unit 44 viewed from below, and FIG. 11 is an assembled perspective view of the base unit 42 and the dust guide unit 44.

The dust guide unit 44 includes the guide portion 442 to guide air, which contains dust brushed away from the surface-to-be-cleaned, to be sucked, and the contact portion 444 to separate the dust attached to the cleaning member 484 of the drum brush 48 while being in contact with the drum brush 48.

The guide portion 442 forms the suction space 446 to guide the dust. The suction space 446 refers to an approximately trapezoidal space having an opened bottom. The suction space 446 includes a dust suction channel 4462 having, for example, a semicylindrical shape at the center of a rear wall 4461. The suction space 446 includes a ceiling 4464 formed to be gradually raised from opposite walls 4463 and 4465 toward the central dust suction channel 4462. A front wall 4466 of the suction space 446 is extended having curvature similar to the curvature of the drum brush 48. The suction space 446 includes a curved portion 44662 recessed in the middle thereof and curved upward.

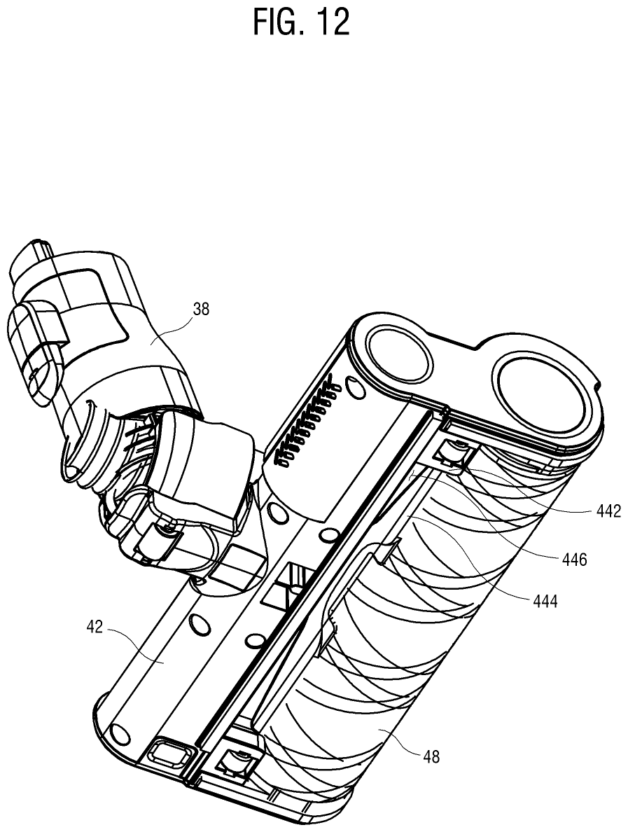

FIG. 12 is a perspective view of the suction unit 4, viewed from below. The contact portion 444 is provide at the edge of the front wall 4466 of the suction space 446 to become into contact with the outer circumferential surface of the drum brush 48 in the lengthwise direction. The contact portion 444 includes a linear contact portion 4442 provided at the edge linearly extended from the opposite ends of the front wall 4466, and a curved contact portion 4444 provided at the edge of the curved portion 44662 in the middle. The linear contact portion 4442 and the curved contact portion 4444 protrude from the outer surface of the front wall 4466. The linear contact portion 4442 and the curved contact portion 4444 are curved to have curvature similar to the curvature of the radius of the outer surface of the drum brush 48, so as to become into contact with the outer circumferential surface of the drum brush 48. Like this, the contact portion 444 is in contact with the outer circumferential surface of the drum brush 48 in the lengthwise direction, thereby not only separating the dust as the drum brush 48 rotates, but also transmitting static electricity to the electric-discharging bristles of the drum brush.

FIG. 13 is a perspective view of the suction unit 4 from which the upper cover 446 is separated. As shown therein, the motor wire 368 may be extended up to the drum motor 49 while being in contact with the top surface of the dust guide unit 44. In result, the motor wire 368 may be connected from the battery 24 of the handy unit 20 to the drum motor 49 via the connection pipe 30 and the dust guide unit 44. Therefore, the static electricity charged in the dust collecting box 23 and/or the connection pipe 30 may be transmitted to the dust guide unit 44 through the motor wire 368.

By friction with dust sucked while the vacuum cleaner 1 is operating, the dust guide unit 44, the connection pipe 30 and the dust collecting box 23 are charged. Like this, the static electricity charged in the dust collecting box 23 and/or the connection pipe 30 is transmitted to the conductive dust guide unit 44 along the motor wire 368. The static electricity transmitted to the dust guide unit 44 is transmitted to the electric-discharging bristles provided in the cleaning member 484 of the drum brush 48 through the contact portion 444, and thus continuously discharged to a surface-to-be-cleaned on the floor.

Although a few embodiments of the disclosure have been illustrated and described, the disclosure is not limited to the foregoing embodiments, and various alternative embodiments can be made by a person having ordinary knowledge in the art without departing from the scope of the disclosure defined in claims, and appreciated within the technical concept or trend of the disclosure.

1. A vacuum cleaner comprising:
a cleaner main body configured to generate suction power; and
a suction unit configured to suck dust using the suction power, the suction unit including:
a drum brush including a drum that is cylindrical and rotatable to brush away dust from a floor, and conductive bristles provided on an outer circumferential surface of the drum; and
a conductive dust guide unit including:
a guide portion connectable to the cleaner main body and configured to guide the sucked dust to be transferred to the cleaner main body, and
a contact portion formed to extend from the guide portion and be in contact with the conductive bristles of the drum brush, the contact portion being configured to transfer static electricity, which is charged as the vacuum cleaner is operated, from the cleaner main body to the conductive bristles of the drum brush.

2. The vacuum cleaner according to claim 1, further comprising:
a drum motor configured to rotate the drum; and
a motor wire configured to supply electric power from the cleaner main body to the drum motor, and provided to be in contact with the dust guide unit.

3. The vacuum cleaner according to claim 2, wherein
the cleaner main body comprises a handy unit comprising a battery, and a connection pipe through which dust guided by the suction unit passes, and
the motor wire is connected from the battery to the drum motor of the suction unit via the connection pipe and the dust guide.

4. The vacuum cleaner according to claim 3, wherein the cleaner main body comprises:
a first connection unit to connect a first end portion of the connection pipe and the handy unit; and
a second connection unit to connect a second end portion of the connection pipe and the suction unit.

5. The vacuum cleaner according to claim 4, wherein the motor wire comprises:
a first power line formed to extend from the battery of the handy unit toward the first end portion of the connection pipe;
a second power line formed to extend along the connection pipe; and
a third power line formed to extend from the drum motor toward the second end portion of the connection pipe.

6. The vacuum cleaner according to claim 5, wherein the cleaner main body comprises:
a first connector to electrically connect the first power line and the second power line; and
a second connector to connect the second power line and the third power line.

7. The vacuum cleaner according to claim 2, wherein the motor wire comprises a plurality of internal electric wires, and an external sheath to cover the plurality of internal electric wires.

8. The vacuum cleaner according to claim 2, wherein
the cleaner main body comprises a dust collecting box configured to collect dust transferred through the connection pipe, and
the dust collecting box is in contact with the connection pipe.

9. The vacuum cleaner according to claim 2, wherein the cleaner main body comprises:
a dust collecting box configured to collect dust transferred through the connection pipe;
a grip configured to allow a user to control the vacuum cleaner; and
a conductive line to electrically connect the dust collecting box and the grip.

10. The vacuum cleaner according to claim 1, wherein
the drum brush is provided on the outer circumferential surface of the drum and comprises cleaning bristles to brush away dust from a floor, and
the contact portion is configured to separate the dust from the cleaning bristles of the drum brush while in contact with the cleaning bristles of the drum brush.

11. The vacuum cleaner according to claim 1, wherein the dust guide unit comprises conductive plastic.

12. The vacuum cleaner according to claim 11, wherein the conductive plastic comprises plastic that contains a conductive filler.

13. The vacuum cleaner according to claim 1, wherein the dust guide unit is coated with a conductive material.

14. The vacuum cleaner according to claim 1, wherein the conductive bristles comprise a conductive wire.
